(19) United States
(12) Patent Application Publication
(10) Pub. No.: US 2014/0057481 A1
(43) Pub. Date: Feb. 27, 2014

(54) CONNECTOR

(71) Applicants: CHIN-MING CHANG, Tu-Cheng (TW); CHING-JOU CHEN, Tu-Cheng (TW)

(72) Inventors: CHIN-MING CHANG, Tu-Cheng (TW); CHING-JOU CHEN, Tu-Cheng (TW)

(21) Appl. No.: 13/664,442

(22) Filed: Oct. 31, 2012

(30) Foreign Application Priority Data
Aug. 27, 2012 (TW) 101130958

(51) Int. Cl. H01R 13/64

(52) U.S. Cl. 439/378

(57) ABSTRACT

A connector includes a main body defining a mounting hole extending through bottom and top sides of the main body, and an indicating pin slidably received in the mounting hole of the main body. When the connector is manipulated to be coupled to an on-board connector, a base of the on-board connector moves the indicating pin upwards to make a top end of the indicating pin extend out of the main body to indicate that the connector is properly coupled to the motherboard.

### BACKGROUND

1. Technical Field

The present disclosure relates to a connector.

2. Description of Related Art

Peripheral devices for computers, such as hard disk drives and optical disk drives, are connected to a motherboard with cables. In assembling the computer, connectors of the cables should be properly coupled to corresponding connectors on the motherboard, otherwise there may be a risk of the peripheral devices being accidently disconnected from the motherboard during use of the computer. However, it is hard to make sure whether the connectors are connected or not.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, exploded view of a first exemplary embodiment of a connector attached to an end of a cable and another connector mounted to a motherboard.

FIG. 2 is an assembled, isometric view of FIG. 1.

FIG. 3 is an isometric, assembled view of a second exemplary embodiment of a connector attached to an end of a cable and another connector mounted to a motherboard.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

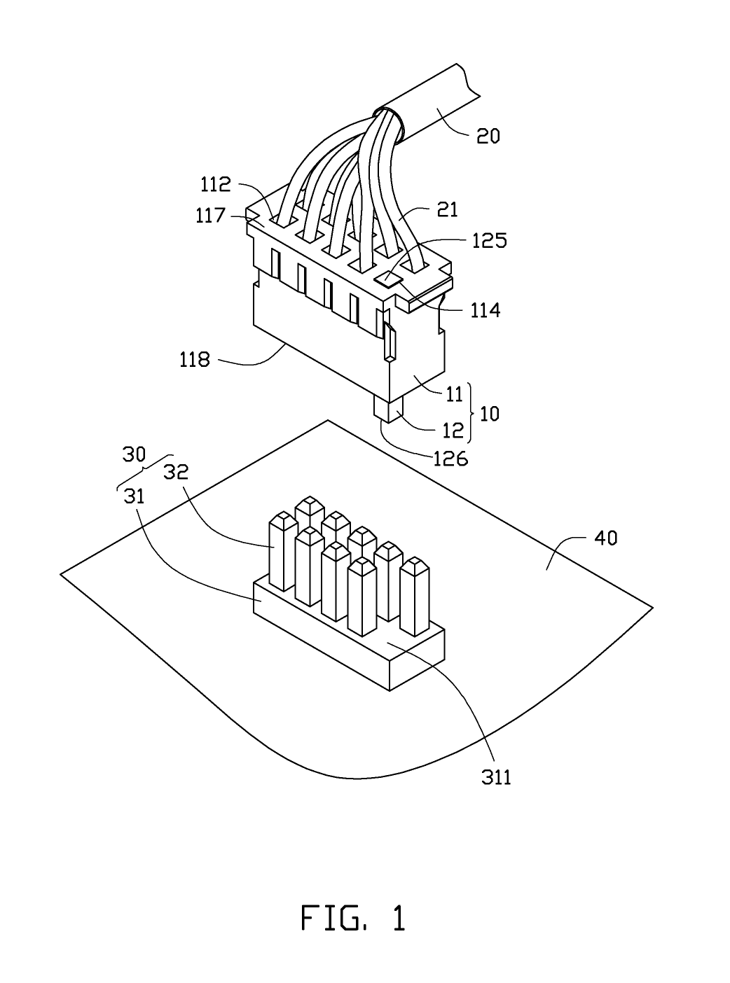

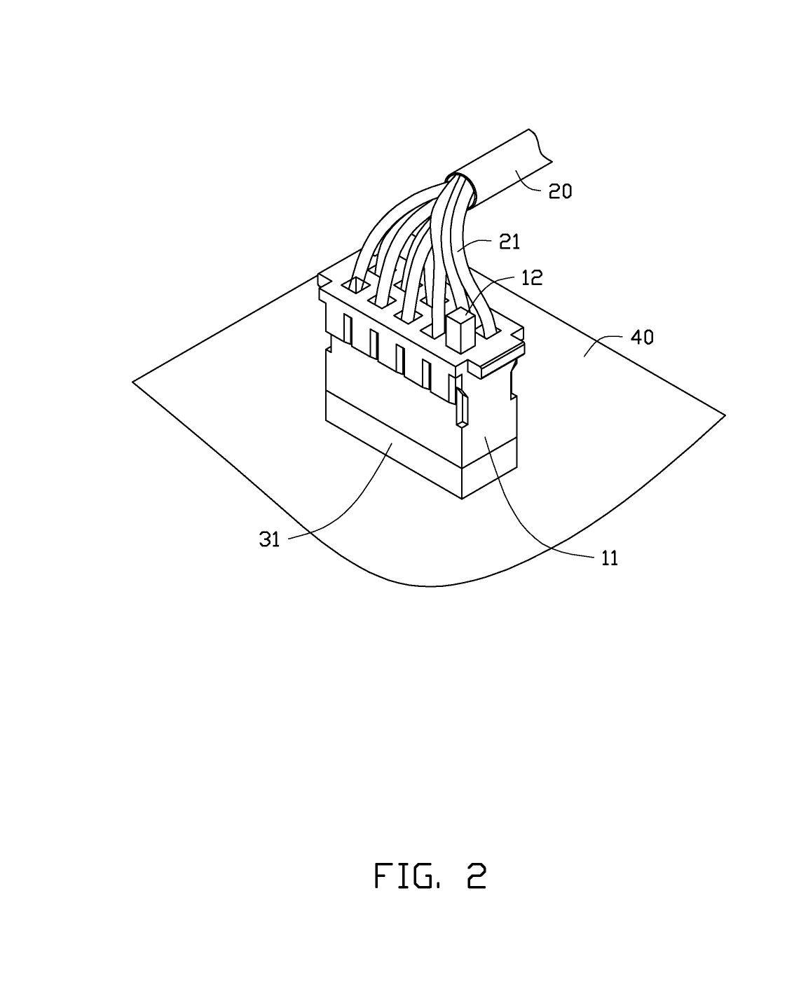

FIGS. 1 and 2 show an exemplary embodiment of a connector 10. The connector 10 is connected to a cable 20 provided to be connected to a connector 30 mounted on a motherboard 40. The cable 20 includes a plurality of leads 21. In one embodiment, the connector 10 is a female connector. The connector 30 is a male connector.

The connector 30 includes a base 31 fixed to the motherboard 40, and a plurality of connecting pins 32 extending up from a top side 311 of the base 31.

The connector 10 includes a main body 11 and an indicating pin 12. A bottom side 118 of the main body 11 has a same contour as the top side 311. A plurality of connecting holes 112 and a mounting hole 114 are defined in the main body 11 and extend through the top and bottom sides 117 and 118 of the main body 11. The number and arrangement of the connecting holes 112 are equal to the quantity of the connecting pins 32. The leads 21 respectively extend into the connecting holes 112 from the top side 117 of the main body 11 and are electrically connected to corresponding terminals (now shown) correspondingly mounted in the connecting holes 112. The indicating pin 12 extends through the mounting hole 114 and is held in place by a friction force between an outside wall of the indicating pin 12 and an inner wall bounding the mounting hole 114. A length of the indicating pin 12 is greater than a depth of the mounting hole 114 of the main body 11, with a bottom end 126 of the indicating pin 12 extending out of the main body 11 and a top end 125 of the indicating pin 12 coplanar with the top side 117 of the main body 11.

In assembly, the connector 10 is coupled to the connector 30, with the connecting pin 32 extending into the corresponding connecting holes 112 of the connector 10 to electrically contact the terminals in the connecting holes 112. When the bottom side 118 of the main body 11 abuts the top side 311 of the base 31 of the connector 30, the base 31 moves the indicating pin 12 upwards to make the top end 125 extend out of the main body 11, thereby indicating that the connector 10 is properly coupled to connector 30.

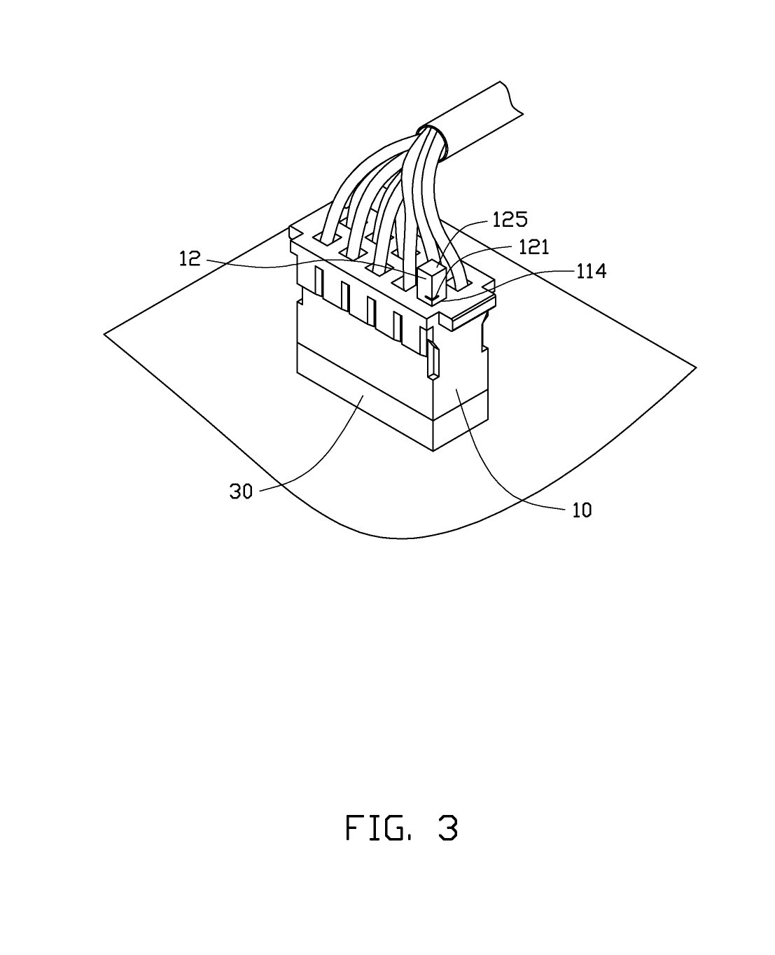

FIG. 3 shows in another embodiment, an indicating mark 121 is formed on one of sidewalls of the indicating pin 12 and adjacent to a top end 125 of the indicating pin 12. In coupling the connector 10 to the connector 30, the indicating pin 12 is moved to slide upwards until the indicating mark 121 is exposed out of the mounting hole 114 to indicate that the connector 10 is properly coupled to the connector 30.

It is to be understood, however, that even though numerous characteristics and advantages of the embodiment have been set forth in the foregoing description, together with details of the structure and function of the embodiment, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A connector, comprising:
a main body defining a mounting hole extending through top and bottom sides of the main body; and
an indicating pin slidably received in the mounting hole;
wherein a length of the indicating pin is greater than a depth of the mounting hole of the main body.

2. The connector of claim 1, wherein the indicating pin is prevented from accidently slipping away from the mounting hole by a friction force between sidewalls of the indicating pin and inner walls bounding the mounting hole.

3. The connector of claim 1, wherein an indicating mark is formed on one of sidewalls of the indicating pin and adjacent to a top end of the indicating pin.

4. An assembly, comprising:
a first connector comprising a main body and an indicating pin, the main body defining a mounting hole extending through bottom and top sides of the main body, the indicating pin slidably received in the mounting hole of the main body;
a cable extending from and electrically connected to the first connector;
a motherboard; and
a second connector comprising a base fixed to the motherboard;
wherein a length of the indicating pin is greater than a depth of the mounting hole of main body, the indicating pin is moved upwards by the base of the second connector to make a top end of the indicating pin extend out of the top side of the main body in response to the first connector being coupled to the second connector.

5. The assembly of claim 4, wherein the first connector is a female connector, the main body of the first connector defines a plurality of connecting holes extending through the bottom and top sides of the main body; the cable comprises a plurality of leads respectively extending into the connecting holes of the first connector from the top side of the main body; the second connector is a male connector, and comprises a plurality of connecting pins extending up from the base to respectively extend into the connecting holes of the first connector from the bottom side of main body.
